(19) United States
(12) Patent Application Publication
(10) Pub. No.: US 2017/0328127 A1
(43) Pub. Date: Nov. 16, 2017

(54) Workstation Divider with Lighting, Privacy, and Power

(71) Applicant: Peter Stathis, The Sea Ranch, CA (US)

(72) Inventor: Peter Stathis, The Sea Ranch, CA (US)

(21) Appl. No.: 15/589,261

(22) Filed: May 8, 2017

Related U.S. Application Data
(60) Provisional application No. 62/334,792, filed on May 11, 2016.

(51) Int. Cl. E06B 9/24; F21S 9/02; A47B 21/06; F21S 6/00; F21V 33/00; F21V 3/00

(52) U.S. Cl. CPC E06B 9/24; F21V 33/006; F21V 3/00; A47B 21/06; F21S 6/003; F21S 9/02

(57) ABSTRACT

A portable workstation divider is disclosed. The workstation divider functionally integrates a lighting fixture with at least one privacy panel and a power outlet or outlets. The lighting fixture typically uses LED-based lighting elements. A single, long privacy panel may be wrapped around and attached to the lighting fixture in some embodiments, while in other embodiments, the lighting fixture may carry elements that establish a sliding track for two privacy panels. The power outlet or outlets may offer either alternating current (AC) or direct current (DC) power for user devices, and may be of any known type, including traditional AC outlets, USB and USB-C outlets, and proprietary types of outlets. Some workstation dividers may be entirely mobile.

### CROSS-REFERENCE TO RELATED APPLICATIONS

This application claims priority to U.S. Provisional Application No. 62/334,792, filed May 11, 2016, the contents of which are incorporated by reference in their entirety.

### BACKGROUND OF THE INVENTION

### 1. Field of the Invention

The invention relates generally to workstation dividers, and more specifically, to workstation dividers with functionally integrated lighting fixtures, privacy screens, and power outlets.

### 2. Description of Related Art

Over the last few years, new ideas about collaboration in the workplace have fueled so-called “open office” floor plans, in which many employees of a company work in a large, open area, often with no privacy walls or screens between them. As more and more companies move away from using private offices and cubicle systems, a question has arisen: what does one do in an open office environment when one needs privacy?

Workers may require privacy when dealing with sensitive matters or documents, when viewing personal or confidential information on their computer screens, and in a plethora of other situations. The challenge lies in creating that privacy in a way that does not disrupt the fundamental nature of the open office concept.

The solution is usually more complex than simply placing privacy screens or panels strategically—in order to be productive in a modern office, most workers require access to power. Localized or task lighting, if not absolutely required, is usually helpful as well. Using conventional fixtures, providing lighting, privacy, and power for multiple workstations in an office can easily become a cumbersome task, and if not carefully planned out and managed, can result in wires and cables snaking across the office willy-nilly.

### SUMMARY OF THE INVENTION

One aspect of the invention relates to a workstation divider that combines and functionally integrates a lighting fixture, one or more privacy panels, and one or more power outlets in order to provide lighting, electrical power, and at least a modicum of privacy in a portable form that can be used individually or as a part of a system. The lighting fixture typically uses lighting elements based on light-emitting diodes (LEDs). In some embodiments, the privacy panel or panels may wrap around and be fixedly attached to the lighting fixture. In other embodiments, an upright bar or post carries the lighting fixture as well as brackets that establish a sliding track, and a pair of privacy panels are disposed in the track. The upright may also be configured to attach to a clamp or to be secured to a tabletop or other supporting surface by other means.

Another aspect of the invention relates to systems using portable workstation dividers that can be used to partition multiple workstations while providing lighting, privacy, and power to each workstation, without relying on large, fixed barriers or negating open office floor plans.

Other aspects, features, and advantages of the invention will be set forth in the description that follows.

### BRIEF DESCRIPTION OF THE DRAWING FIGURES

The invention will be described with respect to the following drawing figures, in which like numerals represent like features throughout the figures, and in which:

FIG. 1 is a perspective view of a workstation divider according to one embodiment of the invention;

FIG. 2 is a top plan view of the workstation divider of FIG. 1;

FIG. 3 is an elevational view of the workstation divider of FIG. 1;

FIG. 4 is a perspective view of the lighting fixture of the workstation divider of FIG. 1 in isolation;

FIG. 5 is a perspective view of the lighting fixture and corner panels of the workstation divider of FIG. 1 in isolation;

FIG. 6 is a perspective view similar to the view of FIG. 1, illustrating a pocket system installed on a privacy panel of the workstation divider;

FIG. 7 is a cross-sectional view of a lower portion of the privacy panel and pocket system of FIG. 6, illustrating the engagement of the two;

FIG. 8 is a perspective view of a workstation divider according to another embodiment of the invention;

FIG. 9 is a side elevational view of the workstation divider of FIG. 8;

and

FIG. 10 is a perspective view of another embodiment of a workstation divider, similar to the embodiment shown in FIG. 8;

FIG. 11 is a perspective view of a plurality of the workstation dividers of FIG. 10 used together systematically to partition multiple workstations;

FIG. 12 is a perspective view of two additional embodiments of workstation dividers, shown as installed systematically on a table, side-by-side and back-to-back, thus creating several separate workstations;

FIG. 13 is a perspective view of a mobile workstation divider according to another embodiment of the invention, shown in a closed configuration; and

FIG. 14 is a perspective view of the mobile workstation divider of FIG. 13, shown in an operational configuration.

### DETAILED DESCRIPTION

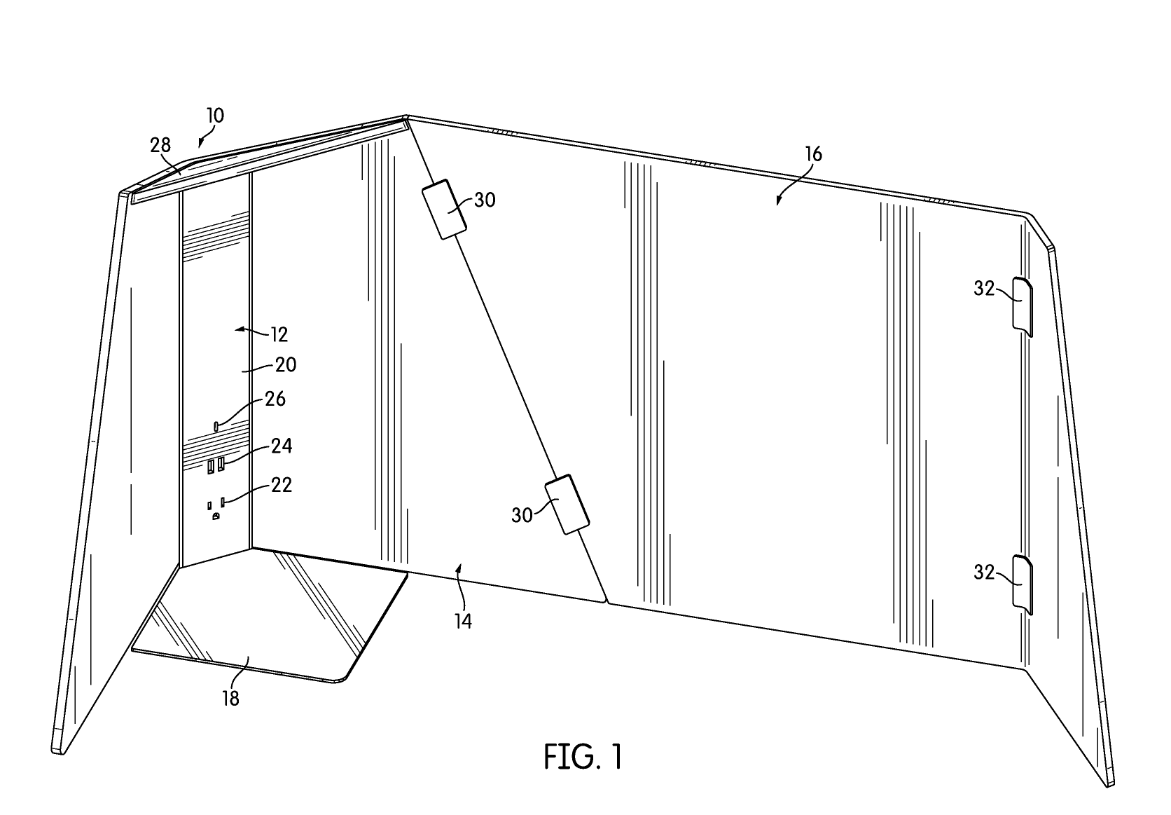

FIG. 1 is a perspective view of a workstation divider, generally indicated at 10, according to one embodiment of the invention. In the embodiment of FIG. 1, the workstation divider 10 comprises three parts that are integrated to work together: a light fixture 12; a set of privacy panels, in this case including both corner panels 14 coupled to the light fixture 12, and an extension panel set 16; and power outlets 22, 24, 26, in this case carried by the light fixture 12. Together, the workstation divider 10 provides local lighting, power for machines and electronics, and privacy. While the panels 14, 16 primarily provide privacy and a degree of acoustical isolation, they may also be used to direct, reflect, and in some cases to diffuse, the light from the light fixture 12. As will be described below in more detail, while the components 12, 14, 16 are designed to be integrated together, in this embodiment, they are separable.

The light fixture 12 of the illustrated embodiment is a table lamp with a base 18 adapted to rest on a table or another flat surface. The base 18 of FIG. 1 is thin and generally rectangular with rounded corners, truncated at one corner where it attaches to the armature or upright 20 of the light fixture 12. The light fixture 12 provides localized lighting, which, for purposes of this description, refers to lighting that provides light to the immediate area around the fixture. Task lighting, a particular type of localized lighting, refers to lighting provided for a specific task. While task lighting is usually localized, it is also typically specialized for a particular task, type of work, or workplace. Various embodiments of the invention may provide either general localized lighting, task lighting, or both, and the two terms may be used interchangeably in this description, unless otherwise indicated. Additionally, the light fixture 12 is a table lamp; if a larger light fixture 12, like a floor lamp, is used, the light fixture 12 may provide some ambient, i.e., general, light to the area at large.

The upright 20 of the light fixture 12 is typically rigid, and depending on the load it is intended to carry, it may be, e.g., extruded or molded aluminum, rigid plastic, or any other suitable structural material. In other embodiments, as will be described below in more detail, the lighting fixture 12 may be designed to clamp or otherwise affix directly to the panel itself or its support surface, in which case, a base 18 may not be provided.

In most embodiments, the workstation divider 10 and its components, including the lighting fixture 12, will be portable. As used in this description, the term “portable” can be defined generally as “not permanently mechanically fixed in place.” Simply put, workstation dividers 10 can be moved and rearranged as necessary to support individual user needs or a larger “open office” floor plan. It should be understood, though, that a “portable” workstation divider 10 may have some form of mechanical fixation in some embodiments—for example, a fixture that is secured with a clamp, bracket, or collar to a table or other structure is still portable, especially when the hardware is intended to be easily disengaged. By contrast, a fixture that is screwed, bolted, or glued to a table or the floor would not be portable, nor would a fixture, like a traditional chandelier, that is permanently mechanically fixed in place. As will be described in more detail below, some embodiments of the invention may also be mobile, meaning that they have no mechanical connection to the surface on which they rest—and may not require a hardwired connection to power, either.

The front face of the upright is relatively flat and carries a plurality of outlets 22, 24, 26. The outlets 22, 24, 26 may be any type of power or power and data outlets known or convenient, including household or commercial alternating current (AC) power outlets, universal serial bus (USB) connectors, USB-C connectors, and LIGHTNING™ connectors (i.e., connectors used by Apple, Inc. devices for charging and data communication). For the sake of simplicity, the term “outlet” is used here to refer to conventional power outlets as well as to ports, jacks, and other such connecting elements for supplying power to devices. The outlets 22, 24, 26 may be male or female in nature. Additionally, while much of this description focuses on the provision of power for user devices and equipment, in some cases, if the outlet 24, 26 is capable of data transmission, it may be connected to an office network or another such system to provide a data connection.

Typically, the lighting fixture 12 itself will take household or commercial AC power (i.e., 110-220 volts). If the outlets 22, 24, 26 require power at different voltages, the lighting fixture 12 will typically include a transformer or, if the supplied power is direct current (DC), a transformer-rectifier. In many cases, that transformer-rectifier will also supply power to the lighting elements themselves. However, some embodiments of a lighting fixture 12 may run on a battery pack, in which case supplying DC power may not require a transformer-rectifier. A DC-powered lighting fixture 12 may use an inverter to supply AC power, if the outlet type requires AC power. Yet other embodiments of lighting fixtures 12 may use other power technologies, like inductive charging and wireless charging.

As those of skill in the art will realize, while it may be convenient for the outlets 22, 24, 26 to be in the lighting fixture 12 as shown, other arrangements are possible. For example, electrical wire, like flat wire, could be run within the panels 14, 16 and outlets 22, 24, 26 thus placed anywhere in or along the panels 14, 16.

In the illustrated embodiment, the upper portion 28 of the lighting fixture 12 is an emitter-diffuser with a generally trapezoidal shape that is canted upwardly relative to the upright 20. The lighting fixture 12 uses flat-panel lighting based on light-emitting diodes (LEDs). The light generated by the LEDs is diffused and emitted by the upper portion 28. In some cases, the connection between the upright 20 and the upper portion 28 may be by way of a modular connector, allowing the upper portion 28 to be replaced or upgraded as necessary.

While LED-based lighting fixtures 12 and flat-panel emitter-diffusers like the upper portion 28 are advantageous in that they are compact, bright, and can be quite portable, the nature of the lighting elements or lamps used in the lighting fixture 12 are not critical to the invention, and in various embodiments, the lighting fixture 12 may provide LED, fluorescent, incandescent, or any other type of light.

On each side of the lighting fixture 12, a corner panel 14 abuts and is attached. Typically, the corner panels 14 would be firmly but removably attached. However, in most embodiments, the corner panels 14 and any extension panels 16 would not be structural or designed to bear high loads. The panels 14 may be connected to the lighting fixture 12 in any number of ways, including, but not limited to, bolts, rivets, clips, hook-and-loop fastener, magnets, or adhesives.

For example, the connections between the panels 14, 16, and between the corner panels 14 and the lighting fixture 12, may be by way of small magnets embedded in the edges of the panels 14, 16, although some edges may have magnets and others may have embedded ferromagnetic targets. The panels 14, 16 may also be connected, e.g., by way of a tongue and groove system, or in any number of other ways. The manner of attachment is not critical, although it is helpful if the panels 14, 16 can be attached to each other and to the lighting fixture 12 easily and without specialized tools. In the illustrated embodiment, pairs of small clips 30, 32 connect abutting edges of the panels 14, 16, one clip 30, 32 located toward the top of the panels 14, 16 and the other located toward the bottom. The clips 30 may either be straight and edge-to-edge or offset at an angle, as in the clips 32.

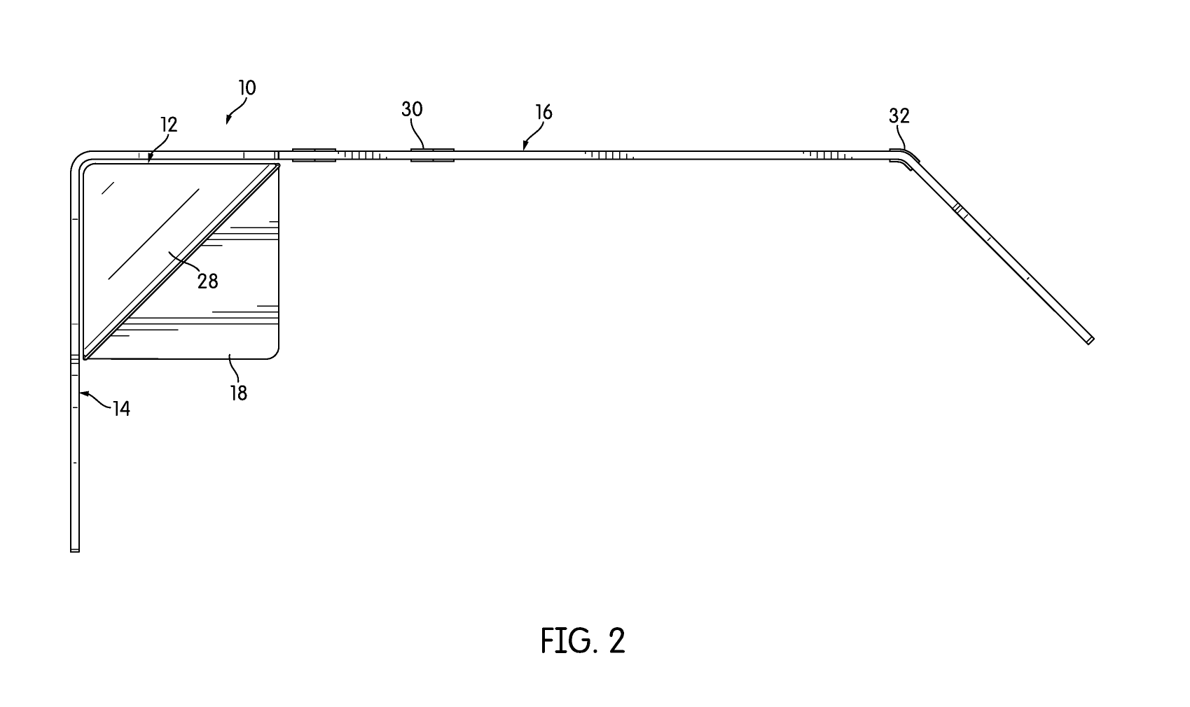

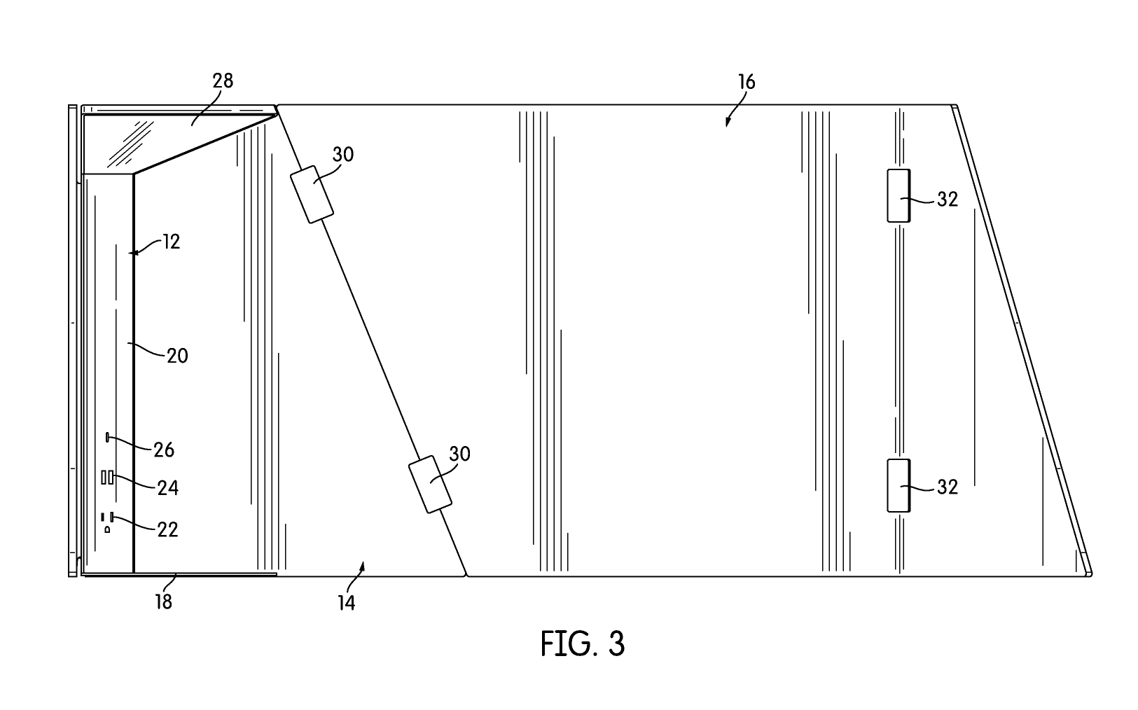

FIG. 2 is a top plan view of the workstation divider 10, and FIG. 3 is an elevational view. In one embodiment, the lighting fixture 12 and panels 14 stand about 18 inches (45.7 cm) high. The corner panels 14 extend out laterally about 15.5 inches (39.4 cm), and the extension panels 16 extend laterally about 31 inches (78.7 cm), and about 7.5 inches (19 cm) inwardly toward the end. In other words, the workstation divider 10 of FIGS. 1-3 is of sufficient size to demarcate and provide privacy around a personal workstation. However, the size of the workstation divider 10 is not limited, and in some embodiments, the lighting fixture 12 may be intended to rest on the floor, may be several feet high, and may have panels 14, 16 of commensurate size. For example, the workstation divider may be on the order of 5-6 feet (roughly 1.75-2 m) high in some cases. When placed on a desk or on the floor, the workstation divider, as depicted, may be placed adjacent to or back-to-back with similar workstation dividers, thus delineating a plurality of work areas.

The panels 14, 16 would typically be made of a material that is at least somewhat rigid, such as heavy cardboard, particle board, plastic, or metal, and may be covered with any number of plastics, fabrics, foam rubbers, paints, coatings, or other materials to provide a desired appearance. In some cases, the covering may serve a useful functional purpose as well. For example, the panels 14, 16 may be covered with an outer layer of acoustical felt or other such material that has sound-dampening properties, along with inner layers of foam rubber. Other materials, like leather, wood, glass, and resins, may be chosen for functional or aesthetic purposes.

As was described above, in general, workstation dividers according to embodiments of the invention provide integrated privacy, power, and light. The workstation divider 10 demonstrates two types of integration: functional integration and aesthetic integration. Functional integration, as the term is used here, refers to the fact that the elements of the workstation divider 10 are specifically designed to work cooperatively together as a cohesive whole, even though some elements may be detachable or configurable by the end user. In other words, the combination of elements is more than a lighting fixture, a set of panels, and a power outlet simply placed on some surface, disassociated from one another. Aesthetic integration means that the elements of the workstation divider 10 share common or complementary aesthetic features that integrate them together visually. Of course, some features provide both functional and aesthetic integration. Virtually all embodiments of workstation dividers will have functional integration; not all embodiments will be aesthetically integrated, or at least, aesthetically integrated to the extent that the workstation divider 10 is.

In the workstation divider 10, the lighting fixture 12 and panels 14, 16 have roughly the same height, a functional integration of those elements. In addition to that, the cant of the upper portion 28 of the lighting fixture 12 matches the angle of the upper edges of the adjacent privacy panels 14, and the side length of the upper portion 28 of the lighting fixture 12 matches the upper side length of the privacy panels 14 or nearly so, features that relate more to aesthetic integration, as do the common trapezoidal shapes.

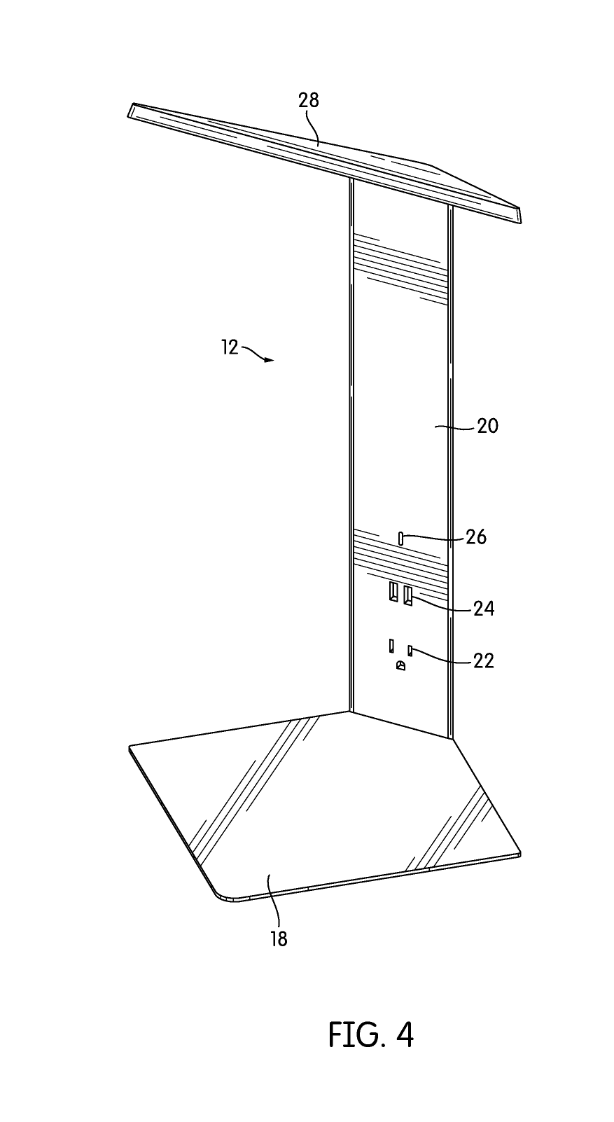

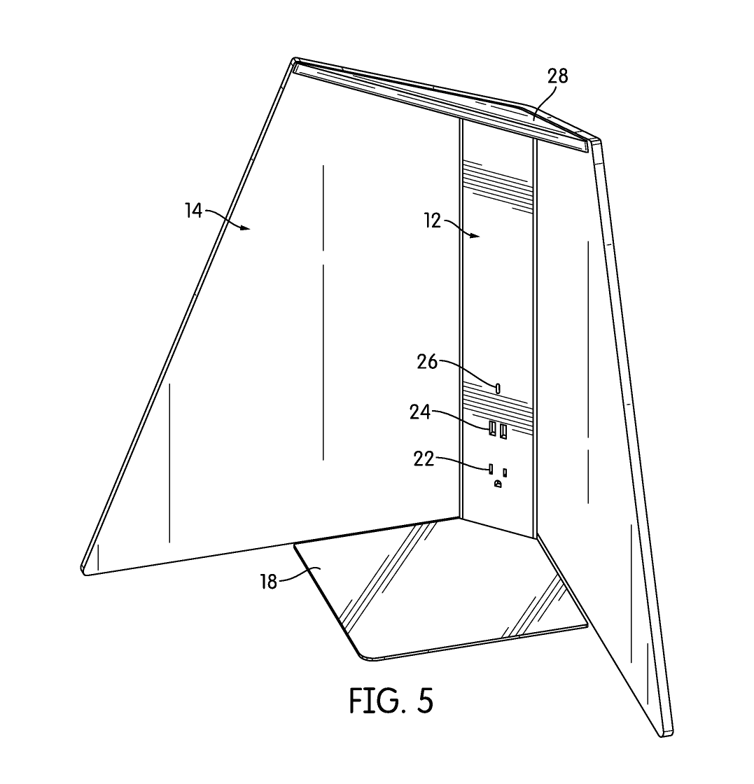

Of course, the elements 12, 14, 16 of the workstation divider 10 are separable, and need not be used together in all embodiments or configurations. FIG. 4 is a perspective view of the lighting fixture 12 in isolation. If light and power are all that is desired, the lighting fixture 12 may be used alone. Similarly, FIG. 5 is a perspective view of the lighting fixture 12 with only its corner pieces 14 installed. If the user wishes to direct or focus the light from the lighting fixture 12, and needs a modicum of privacy in the immediate area but does not need to fully partition a workstation, the arrangement of FIG. 5 may be particularly appropriate. As was described above, in the illustrated embodiment, the panels 14, 16 are approximately the same height as the lighting fixture 12; however, in other embodiments, they may be taller than the lighting fixture 12 itself or at least somewhat shorter, so long as they provide a modicum of privacy appropriate to the task and application.

Beyond the arrangements illustrated in these figures, there is no practical limit to the size, extent, or direction of the panels 14, 16, or to the number of lighting fixtures 12. A number of workstation dividers 10 and constituent elements 12, 14, 16 may be combined into a labyrinthine construct of arbitrary shape and extent that divides several different work areas. Moreover, although the panels 14, 16 are shown as being thin and flat in the illustrated embodiment, they need not be thin or flat in all embodiments. Similarly, although the panels 14, 16 are shown as being divided in various places, the workstation divider 10 may use a single-piece panel.

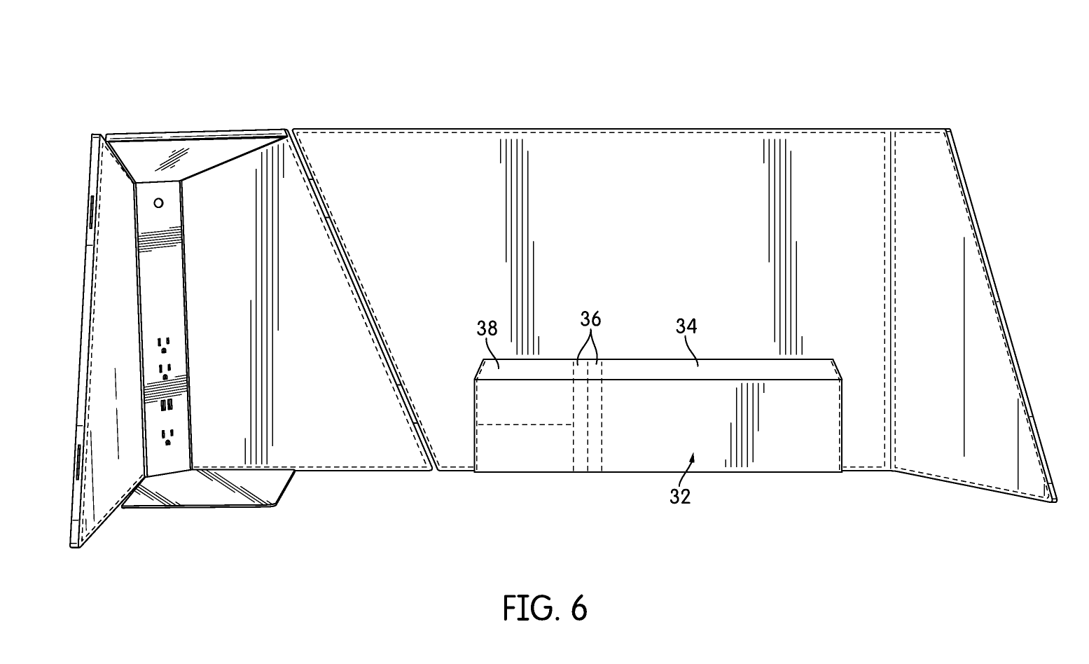

Other accessories and attachments may also be provided. For example, FIG. 6 is a perspective view of the workstation divider 10 similar to FIG. 1. However, as was described briefly above, the workstation divider 10 of FIG. 6 dispenses with external connectors between the panels 14, 16 in favor of edge-mounted magnets and corresponding edge-mounted metal plates. In addition, an organizer pocket system 32 is installed. The organizer pocket system 32 is divided into a number of large and small individual pockets 34, 36, 38.

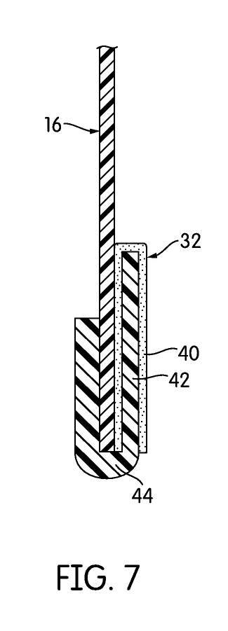

FIG. 7 is a cross-sectional view of the extension panel 16, illustrating the installation of the pocket system 32. The pockets 34, 36, 38 are defined by a layer of fabric 40, stiffened fabric, vinyl, or other suitable material. A generally rigid insert 42, made of a plastic (such as acrylic) or board inserts into the fabric 40 and has a U-shaped portion 44 that receives the bottom of the extension panel 16 and curves around the back of the extension panel 16. The U-shaped portion 44 may be shaped such that it essentially clamps onto the bottom of the extension panel 16. Of course, other attachment mechanisms may be used. The pockets 34, 36, 38 may be made of or covered with the same fabrics as the panels 14, 16, or they may be made of different materials.

In the workstation divider 10 of FIGS. 1-7, the lighting fixture 12 forms the center of the piece, and the panels 14, 16 extend outwardly from the lighting fixture 12, making a roughly 90° angle with respect to each other. Other arrangements of power, privacy panels, and lighting are possible.

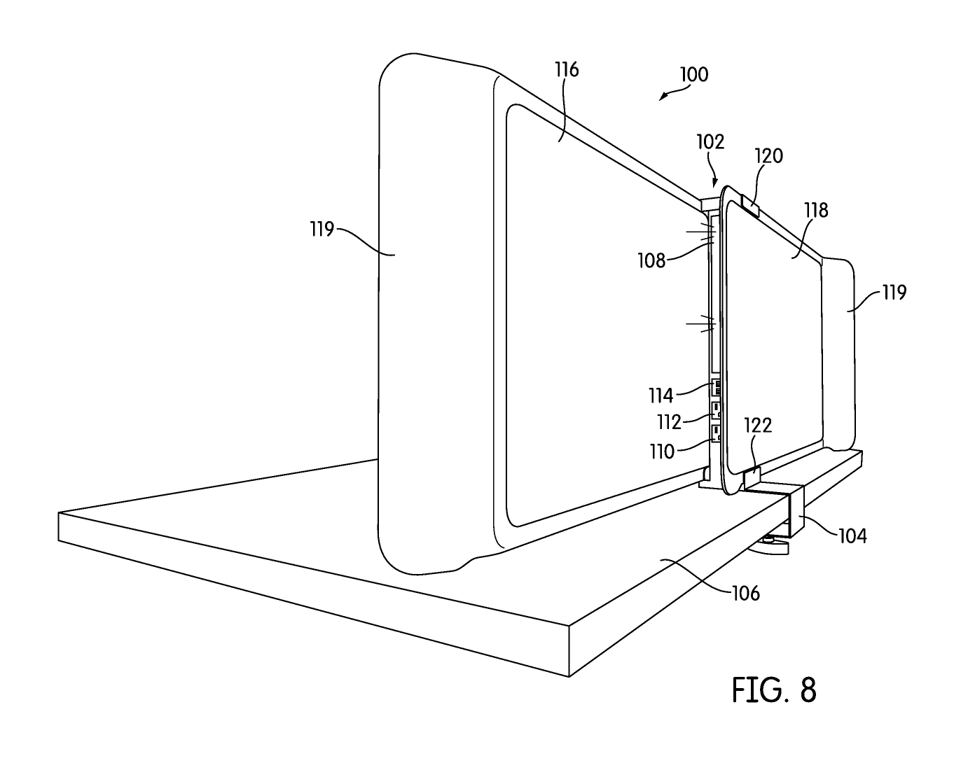

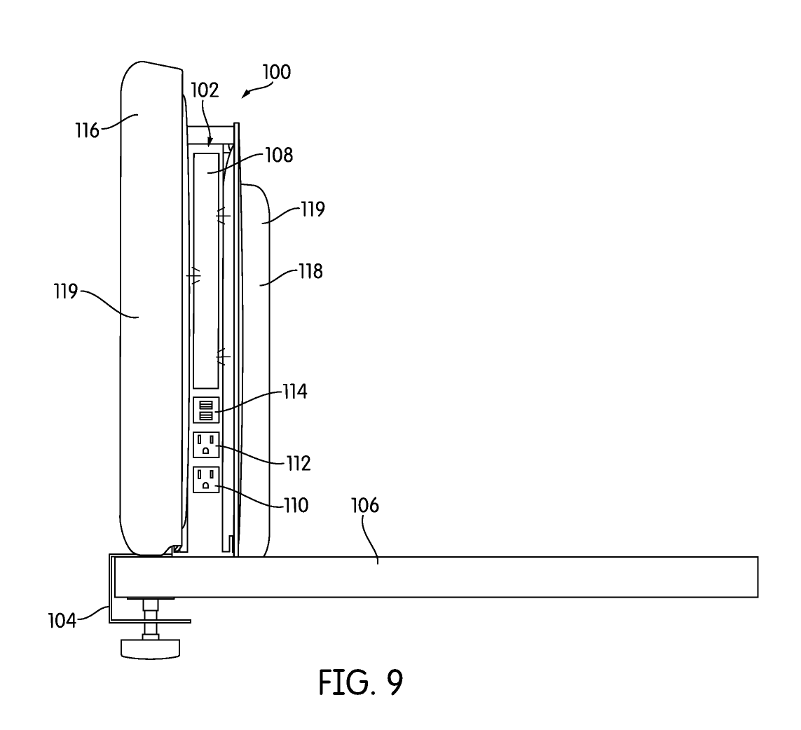

FIG. 8 is a perspective view of a workstation divider 100 according to another embodiment of the invention, and FIG. 9 is a side elevational view of the workstation divider 100. In the workstation divider 100, a vertical upright 102 is secured by a clamping structure 104 to the work surface 106. In other embodiments, a vertical upright 102 may be a set-in-grommet type of arrangement, such that it may be inserted directly into an appropriate receptacle in the work surface 106. As was described above, both arrangements are considered to be portable.

The upright carries lighting elements 108, which would typically be LED lighting elements, but may be fluorescent, incandescent, or of any other type, as well as power outlets 110, 112, 114, which may be of the same varieties described above. Two panels 116, 118 are mounted relative to the upright 102 by upper and lower brackets 120, 122 that essentially define horizontal sliding tracks for the two panels 116, 118. While the power outlets 110, 112, 114 are shown as being in the upright 102, as with the workstation divider 10, in some cases, wires may be run within the panels 116, 118 so that power outlets can be provided elsewhere on the workstation divider 100.

In contrast to the workstation divider 10 described above, the upright 102 is essentially “sandwiched” in between the two panels 116, 118 with one panel 116 in front of it and facing the workstation, and the other panel 118 behind it. In the illustrated embodiment, the lighting elements 108 throw their light to the sides, instead of directly into the partitioned workstation, providing localized but indirect light and, at least to some extent, relying on the panels 116, 118 to reflect, diffuse, and direct that light into the area of the workstation.

As in the workstation divider 10 described above, the panels 116, 118 may have a unitary or a multi-layer construction. In some embodiments, the materials of which the panels are made may be chosen for their optical or diffusing effect on the light; in many embodiments, the panels 116, 118 will be constructed to provide some degree of acoustical dampening or privacy. For example, the panels 116, 118 may have a multi-layer construction that includes a stiffening core panel covered by layers of foam rubber or other foam material and topped by an outermost layer of acoustical felt. Typically, the panels will be reversible, suitable for one-sided use or for two-sided use (i.e., one workstation on each side of the panels 116, 118).

In the illustrated embodiment, because the arrangement of the panels 116, 118 is far more linear than in the workstation divider 10, each panel 116, 118 includes a bent end flap 119 that provides at least some isolation along the sides of the workstation. The end flap 119 is an optional feature, and may be omitted in some embodiments. The end flap 119 extends, e.g. several inches, and may be connected to the panels 116, 118 in any one of several ways. In some cases, the end flap 119 may be a contiguous part of its panel 116, 118 with a fixed angle relative to the main extent of the panel 116, 118. In other cases, there may be living hinge between the end flap 119 and the main extent of its panel 116, 118, i.e., a hinge created by omitting a stiffening core in a portion of the panel 116, 118, such that the outer covering layers form a flexible hinge. In yet other cases, a malleable material, such as a thin strip of metal, may be placed in a hinge area, allowing a user to bend the end flap 119 to a desired position. The end flaps 119 may also extend downwardly to contact the table or other surface on which the workstation divider 100 rests. If the panels 116, 118 have a directionality to them—i.e., if they are “left handed” or “right handed”—then they would preferably also be made to be invertible, such that a single panel 116, 118 can serve either as a left-handed panel or as a right-handed panel.

The upright 102 itself may be modular in construction such that, for example, an easily removable and replaceable module carries the power outlets 110, 112, 114, and a second module carries the lighting elements 108, both within an upright framework. In the illustrated embodiment, the upright 102 is a square or rectangular bar, although other shapes may be used.

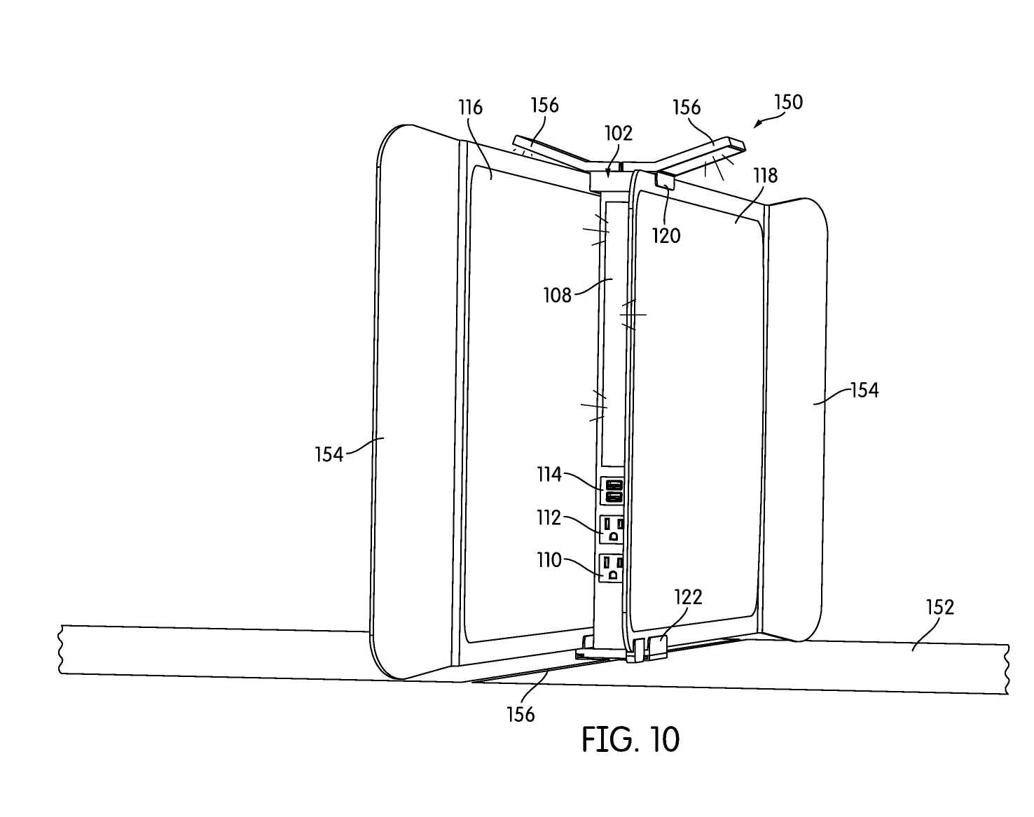

FIG. 10 is a perspective view of a workstation divider 150 that is similar to the workstation divider 100 described above. Unless otherwise indicated, the workstation divider 150 can be assumed to have the same features as the workstation divider 100 described above.

The workstation divider 150 has an upright 102 attached to a table 152. The upright 102 carries upper and lower brackets 120, 122 that form a sliding track for its two panels 116, 118. The two panels 116, 118 have end flaps 154 with a slightly different shape than the end panels 119 of the workstation divider 100, and extend downwardly to contact the table 152. The upright 102 itself carries a lighting element 108, as well as power outlets 110, 112, 114.

In the embodiment of FIG. 10, the table 152 has a cable trough 156, a channel intended to carry power and cabling for common office systems, like audiovisual presentation systems. The clamp, bracket, or other structure that secures the upright 102 in this embodiment rests within the trough 156. This is one distinction between the workstation dividers 10, 100 described above and the workstation divider 150: the description above assumes that the table or other surface on which the divider 10, 100 rests is unremarkable, not adapted to mount or cooperate with the divider 10, 100. However, if a table 152 is equipped with a cable trough 154 or another such structure, the workstation divider 154 may use that structure for mounting, and also for power and data connections.

As was explained above, the upright 102 and its lighting element 108 are positioned to provide localized but indirect lighting. In order to provide more direct task lighting, the workstation divider 150 also includes a pair of task lights 156 mounted atop the upright 102 and extending over each workstation. The task lights 156 would typically be LED lights, although other types of lights could also be used. The task lights 156 are an optional feature that may be included in some embodiments or installations and not others. Moreover, the task lights 156 may be connected to the upright 102 by way of a modular connector, such that they can easily be detached, and the upright 102 capped, if no task lights 156 are installed.

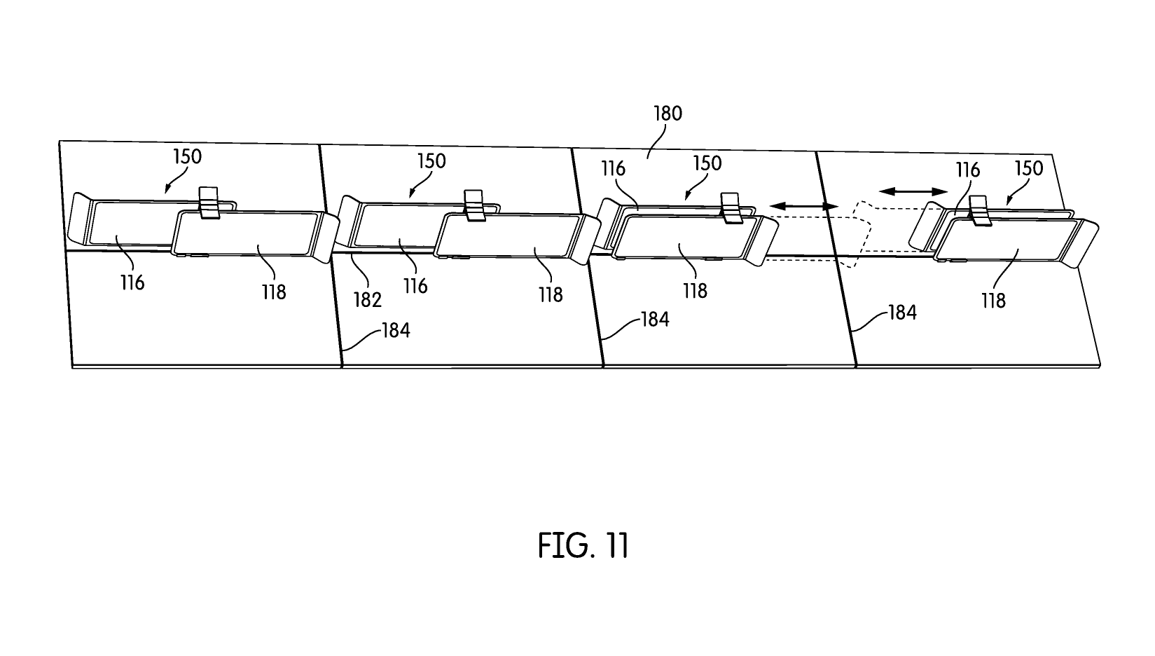

FIG. 11 is a perspective view showing four workstation dividers 150 being used together in a systemic fashion to partition several workstations along a long table 180 that includes both longitudinal and transverse troughs 182, 184 for cabling. In the illustration of FIG. 11, the first two workstation dividers 150 have their panels 116, 118 fully extended. However, the last two workstation dividers 150 have their panels 116, 118 slid back into a retracted configuration that allows two workers to communicate and collaborate across the table 180, if necessary. One particular advantage of dividers 100, 150 with easily repositionable panels 116, 118 is that the panels 116, 118 can be moved out of the way to allow for face-to-face collaboration if desired.

While FIG. 11 illustrates four workstation dividers 150 arranged in a line along a longitudinal trough 182 in the table 180, any number of different configurations may be used. For example, the workstation dividers 150 may be arranged in an H-shape or an I-shape, with some dividers that extend longitudinally and others that extend transversely.

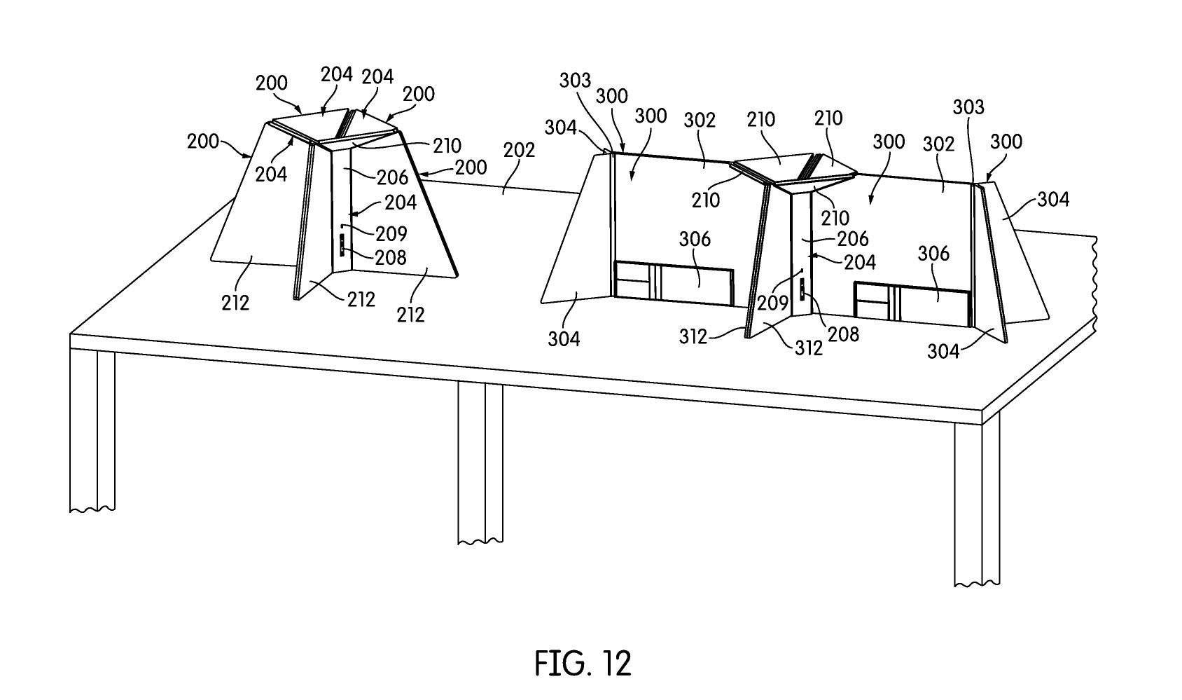

The other workstation dividers 10 described above may also be used as part of a system to partition many workstations. FIG. 12 is a perspective view illustrating workstation dividers 200, 300 according to other embodiments of the invention, shown as installed on a table 202. The workstation dividers 200, 300 are similar to the workstation divider 10 described above, and may be assumed to have the same or similar features unless otherwise indicated. More specifically, in the illustration of FIG. 12, there are four workstation dividers 200 and four workstation dividers 300, shown adjacent and back-to-back, such that in the illustration of FIG. 12, four workstation dividers 200 define four individual workstations and four workstation dividers 300 define another four individual workstations.

Each workstation divider 200 has a lighting fixture 204. The lighting fixture 204 is generally similar to the lighting fixture 12 described above, in that it has an armature or upright 206 on which a plurality of outlets 208 are provided and an upper portion 210 that serves as an LED emitter-diffuser. The upper portion 210 in this embodiment is also trapezoidal, and while any shape could be used, the trapezoidal shape of the upper portion 210 allows four workstation dividers 200 to fit adjacent and back-to-back with one another neatly. In this embodiment, the connectors 208 are all USB or USB-C connectors, and an additional power indicator light 209 is provided.

As compared with the lighting fixture 12 described above, the lighting fixture 204 omits a base—it is comprised solely of the upright 206 and upper portion 210. Instead of multiple panels, the workstation divider 200 uses a single, continuous panel 212 that is bent around the lighting fixture 204 at a living hinge, or another suitable type of bend point, to provide an appearance that is similar to that of the workstation divider 10, albeit with fewer parts and somewhat less complexity. The panel 212 makes about a 90° angle around its bend point, although other angles are possible. The bend need not be a sharp bend; the panel may have a broad hinge that allows for a reasonable radius of curvature around the lighting fixture. The panel 212 of the illustrated embodiment is bolted to the lighting fixture 204 along the rear of the lighting fixture 204, although any means of secure attachment may be used in other embodiments, including magnets, adhesives, hook-and-loop fastener, and the like. The panel 212 itself may be of unitary or multi-layer construction, and as with the other embodiments, may be equipped with acoustical dampening materials, like an acoustical felt.

The workstation dividers 300 are similar to the workstation dividers 200, in that they use the same lighting fixture 204 and share many other features. Like the workstation divider 200, the workstation divider 300 uses a long, continuous panel that “wraps around” the lighting fixture 204 at a living hinge and is secured to the lighting fixture 204, again by bolts or other suitable means. That long panel has a short, trapezoidal section 312 that is generally similar to the appearance of the panel 212. Emerging from the other side of the lighting fixture 204 is a rectangular panel 302 that is connected by way of a living hinge 303 to a trapezoidal end flap 304. Of course, the nature of the hinge 303 may vary from embodiment to embodiment. A set of pockets 306 is provided along the long, rectangular panel 302. As with the workstation divider 200, the workstation divider 300 provides the same basic functions as the workstation divider 200, albeit with fewer parts and slightly less complexity. Of course, FIG. 12 illustrates only one potential configuration of workstation dividers 200, 300; other configurations may be used.

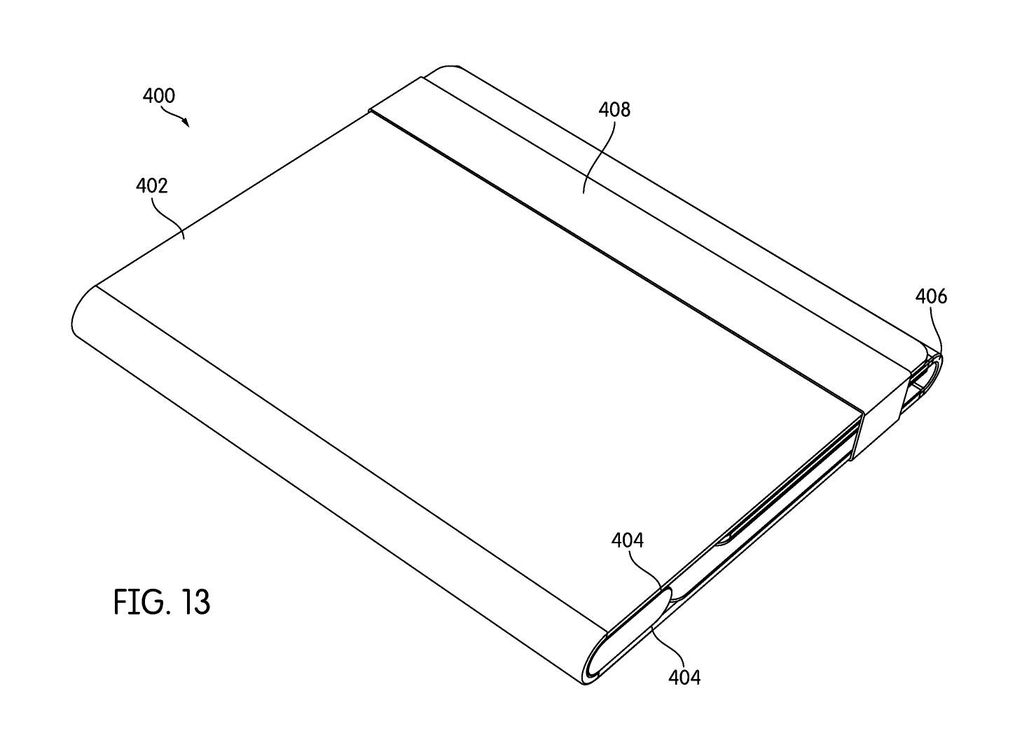

The workstation dividers 10, 100, 150, 200, 300 described above are all portable. As was briefly noted above, embodiments of the invention may also be made mobile—i.e., with no mechanical connection to a surface, and optionally, no electrical connection either. FIG. 13 is a perspective view of a mobile workstation divider, generally indicated at 400. When a workstation divider is mobile, it may be advantageous if that workstation divider can also be folded or otherwise reconfigured for storage and transport when not in use, although such features are not required. The workstation divider 400 has a storage configuration, and FIG. 13 illustrates it in that configuration.

Specifically, the workstation divider 400 has a tri-fold folio configuration. A single panel 402 has several living hinges 404, 406 that allow it to fold into the folded configuration depicted in FIG. 13, and a band 408, latch, or other such structure may retain it in the folded configuration.

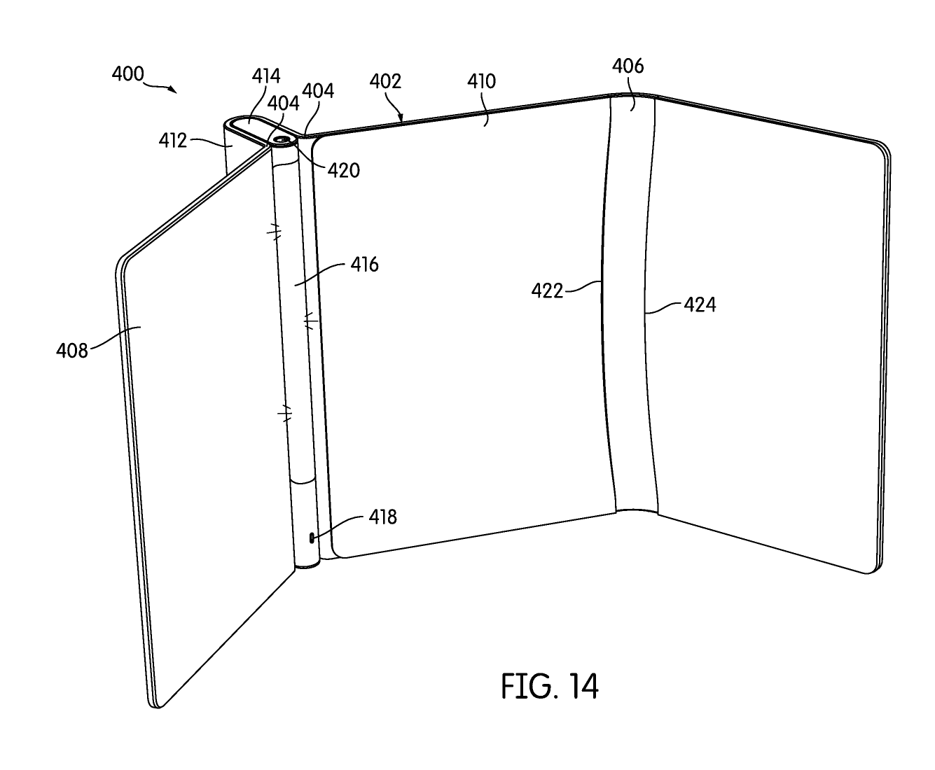

FIG. 14 illustrates the unfolded, operational configuration of the workspace divider 400. The panel 402 includes several sections that are divided by the hinges 404. A single panel 408 emerges on one side, and a double panel 410 that incorporates the living hinge 406 emerges on the other side. Between the single panel 408 and the double panel 410, the panel 402 defines a channel 412 that, in the illustrated embodiment, is U-shaped. Fitting snugly in that channel 412 is a self-contained light and power unit 414 that includes both a lighting element 416, typically an LED-based lighting element, and a single power outlet 418, which may be any of the types of outlet described above. Because of the hinges 404, 406, the panels 408, 410 may be moved into any desired configuration on a desktop to provide privacy.

The light and power unit 414 would typically include an internal battery, although other types of power sources may be used, including solar power. A port 420 may be provided for charging the light and power unit 414, or it may charge using inductive or other wireless technologies. In the illustrated embodiment, the fit between the channel 412 and the light and power unit 414 is snug, and although the two components need not be mechanically fixed to one another, in some embodiments, hook-and-loop fastener, magnetic attachment, or other means of securement may be used. Of course, one advantage of making the light and power unit 404 removable is that it can be easily removed for charging and replaced when charging is complete.

As a folio, the workstation divider 400 may also include pockets that serve as protective storage for laptops, tablet computers, and other things. The workstation divider 400 of FIG. 14 has two such pockets, 422, 424, each spanning much of one surface of the double panel 410, although in other embodiments, the pockets may be smaller or partitioned differently.

Each of the workstation dividers 10, 100, 200, 300, 400 described above functionally integrates lighting, power, and privacy. However, as can be understood from the foregoing, different embodiments can integrate those three things together in different ways. In addition to the functional benefits that workstation dividers 10, 100, 200, 300, 400 offer individual users, they may also have advantages for an office facility manager: by integrating multiple functions into one product, they not only facilitate the “open office” concept, but also make it easier to order and set up.

While the invention has been described with respect to certain embodiments, the description is intended to be exemplary, rather than limiting. Modifications and changes may be made within the scope of the invention, which is defined by the appended claims.

What is claimed is:

1. A portable workstation divider, comprising:
a lighting element;
at least one privacy panel functionally integrated with the lighting element; and
at least one power outlet integrated into the lighting element or the at least one privacy panel.

2. The portable workstation divider of claim 1, wherein the lighting element uses light-emitting diode (LED) lighting elements.

3. The portable workstation divider of claim 2, wherein the at least one privacy panel has about the same height as the lighting element.

4. The portable workstation divider of claim 3, wherein the power outlet is carried by the lighting element.

5. The portable workstation divider of claim 4, wherein the at least one privacy panel extends around, and is fixedly attached to, the lighting fixture.

6. The portable workstation divider of claim 5, wherein the at least one privacy panel is bent around the lighting fixture and is fixedly attached to the lighting fixture at the bend.

7. The portable workstation divider of claim 6, wherein respective ends of the at least one privacy panel make an angle of about 90° with respect to one another, with the lighting fixture.

8. The portable workstation divider of claim 4, wherein the at least one privacy panel comprises two privacy panels.

9. The portable workstation divider of claim 8, wherein the lighting fixture is attached to or carried within elements that define a linear track in which the privacy panels are permitted to slide.

10. The portable workstation divider of claim 9, wherein the lighting fixture and the at least one power outlet are carried by an upright bar or post that is adapted to clamp or fix to a table.

11. The portable workstation divider of claim 3, wherein the power outlet is an AC power outlet, a USB power outlet, a USB-C power outlet, or a LIGHTNING connector.

12. A portable workstation divider, comprising:
a lighting fixture having light-emitting diode (LED)-based lighting elements;
at least one power outlet carried by the lighting fixture; and
at least one privacy panel, the at least one privacy panel having a height approximately equal to a height of the lighting fixture and extending around the lighting fixture.

13. The portable workstation divider of claim 12, wherein the at least one privacy panel is attached to the lighting fixture.

14. The portable workstation divider of claim 13, wherein the at least one privacy panel comprises one or more hinge portions.

15. The portable workstation divider of claim 14, wherein the lighting fixture emits light into an area defined, at least in part, by the privacy panels.

16. The portable workstation divider of claim 15, wherein the workstation divider is mobile.

17. The portable workstation divider of claim 13, wherein the lighting fixture comprises an upright portion and a light-emitting portion.

18. The portable workstation divider of claim 17, wherein the at least one power outlet is carried by the upright portion of the lighting fixture.

19. A portable workstation divider, comprising:
an upright;
a lighting element disposed within the upright;
one or more power outlets disposed within the upright;
a set of brackets attached to the upright, the set of brackets establishing a sliding track; and
a set of privacy panels adapted to be disposed in the sliding track.

20. The portable workstation divider of claim 19, wherein the upright is adapted to attach to a clamp.
